(19) United States
(12) Patent Application Publication
(10) Pub. No.: US 2006/0198614 A1
(43) Pub. Date: Sep. 7, 2006

(54) RECORDING METHOD FOR A DISK DRIVE

(76) Inventor: Hsin Liu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,196

(22) Filed: Dec. 19, 2005

(30) Foreign Application Priority Data
Dec. 24, 2004 (TW) 093140868

(51) Int. Cl. H04N 5/85

(52) U.S. Cl. 386/126

(57) ABSTRACT

A recording method for a disk drive inputs A/D video signals to a multi-disc disk drive which connects with a display device. The display device displays A/D video signals for deciding to record. The multi-disc disk drive has a plurality of storage areas and options of a long-term record mode and a classification record mode. When selecting the long-term record mode, the multi-disc disk drive automatically shifts each disk drive to continuously record in order. When selecting the classified record mode, the multi-disc disk drive records A/D video signals in the predetermined storage area. The multi-disc disk drive can connect a hard disk as a primary recording unit to increase recording time and to easily classify and store data.

### BACKGROUND OF THE INVENTION

1. Field of the Invention

The present invention relates to a recording method for a disk drive, and more particularly to a multi-disc disk drive capable of recording for a long period of time.

2. Description of the Prior Art

Since the multimedia technology promptly develops, the storage capacity of an optical disc is more and more large. And due to the features of easily storing and sharing, optical discs are becoming the main stream of data storage. As shown in FIG. 1, a prior recording method uses a wire 2 to connect a display device 1, such as a TV or a digital camcorder, with a recordable disk drive 3, and a recordable optical disc 4 is inserted into the disk drive 3. A/D digital or analog video signals are received by the disk drive 3 to display video on the display device 1 through the wire 2, and favorable signals of channels, images, or digital videos are selected out. Then, start the disk drive 3 to record those favorable signals onto the optical disc 4. Finally, the recorded optical disc 4 is able to be removed from the disk drive 3 to preserve it or to enjoy it together with friends anytime.

However, the storage capacity of DVD, the largest one of current discs, is about 4-5 Gbye, capable of storing about 8 hours video data at most. It doesn't meet the demand of recording the image of a monitor for a long period of time, or copying mass data. If need be, it is necessary to constantly and manually changed the optical disc 4. Meanwhile, it is hard to avoid the discontinuity of data during changing the optical disc 4, so it is still inconvenient. Besides, there are some prior recording methods directly recording video data with a hard disk, which has a storage capacity, up to about 100 Gbye, to meet the demand of recording the image of a monitor for a long period of time. But the hard disk can not be removed from the disk drive to share it together with others, it is still inconvenient.

### SUMMARY OF THE INVENTION

It is one object of the invention to provide a recording method for a disk drive, which uses a multi-disc disk drive to continuously record for a long period of time and to achieve the integrity of recording data.

It is another object of the invention to provide a recording method for a disk drive, which records various data on different discs, based on the feature of data, to conveniently classify data for preserving or sharing.

It is further object of the invention to provide a recording method for a disk drive, which uses the cooperation of a multi-disc disk drive and a hard disk to increase the time of recording, simplify the operation of recording, and conveniently classify data.

For achieving the above objects, the recording method of the present invention utilizes a multi-disc disk drive with two operation modes. Two operation modes include a long-term record mode and a classification record mode for the option of users. When selecting the long-term record mode, the multi-disc disk drive automatically shifts each disk drive to continuously record in order for increasing the recording time. When selecting the classified record mode, the multi-disc disk drive records A/D video signals in the predetermined storage area so as to store the same kind of data on the same disc.

The recording method of the present invention inputs A/D video signals to a multi-disc disk drive which connects with a display device. The display device displays A/D video signals for deciding to record. The multi-disc disk drive has a plurality of storage areas and options of a long-term record mode and a classification record mode. When selecting the long-term record mode, the multi-disc disk drive automatically shifts each disk drive to continuously record in order. When selecting the classified record mode, the multi-disc disk drive records A/D video signals in the predetermined storage area. The multi-disc disk drive can connect a hard disk as a primary recording unit to increase recording time and to easily classify and store data.

Further features and advantages of the invention, as well as the structure and operation of various embodiments of the invention, are described in detail below with reference to the accompanying drawings.

### BRIEF DESCRIPTION OF THE DRAWINGS

FIG. 1 is a schematic view showing the connection of a prior recording method.

FIG. 2 is a schematic view showing the connection of the recording method of the first embodiment according to the present invention.

FIG. 3 is a flow chart of the first embodiment according to the present invention.

FIG. 4 a schematic view showing the connection of the recording method of the second embodiment according to the present invention.

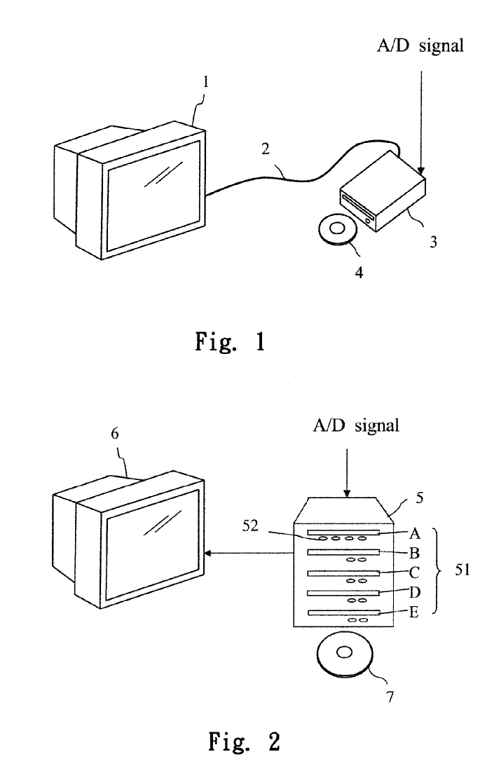

### DETAILED DESCRIPTION

Referring to FIG. 2, the first embodiment of the present invention includes a multi-disc disk drive 5 which is connected to a display device 6, such as a digital camcorder or a TV, and receives A/D digital or analog video signals. The multi-disc disk drive 5 includes a plurality of storage areas, such as disk drives 51 of disk drive A, B, C, D, and C, capable of respectively inserting a disc 7. When A/D digital or analog video signals are transmitted through the multi-disc disk drive 5 to the display device 6 to present the A/D digital or analog video signals, a user can choose operation modes with an option button 52 based on personal favorite. The multi-disc disk drive 5 can be changed to a long-term record or a classification record.

Basically the multi-disc disk drive 5 includes two operation modules, which are a long-term record mode and a classification record mode. When starting the long-term record mode, the multi-disc disk drive 5 will automatically, sequentially shift each disk drive 51 to complete record operation based on the order of disk drive A, B, C, D, and C. That is, when one disk drive 51 finishes record operation, the multi-disc disk drive 5 automatically starts next disk drive 51 for record operation, and stops the record operation until the last disk drive 51 is completed or received a stop command of recording. Therefore, the multi-disc disk drive 5 achieves a continuous record for a long period of time. In the case of the classification record mode, a user first needs to arrange the storage feature of each disk drive 51. When starting the classification record mode, the multi-disc disk drive 5 records wanted video data in an appointed disk drive 51 such that data of the similar feature are stored on the same optical disc for convenience of use or classification.

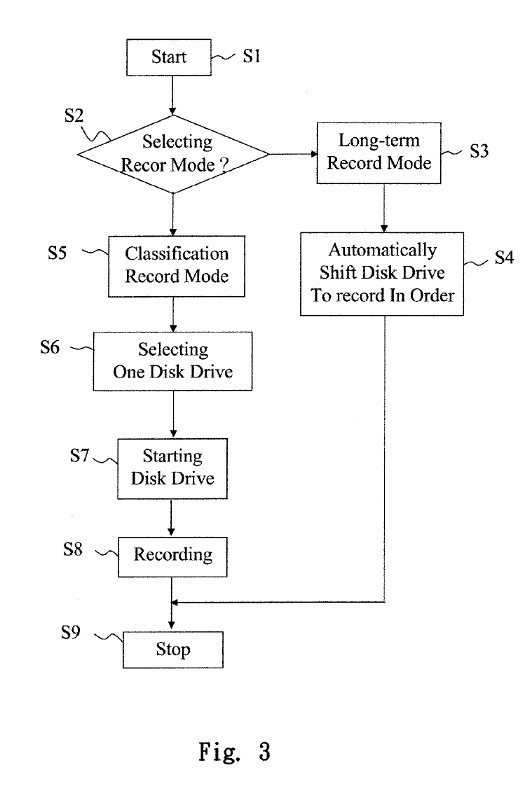

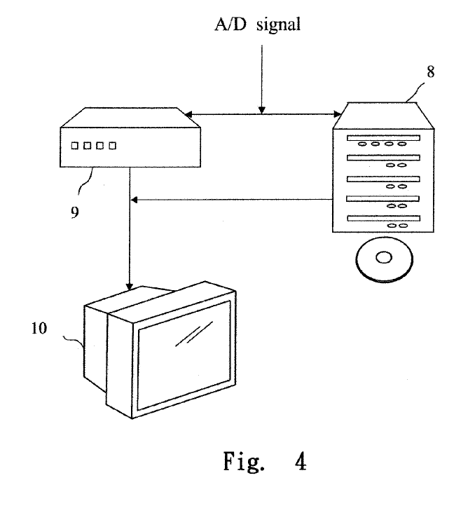

As shown in FIG. 3, when operating, the first step S1 is to start the multi-disc disk drive 5 of the present invention to input A/D digital or analog video signals. The multi-disc disk drive 5 transfers video signals to a display device 6 displaying video signals on a screen. Based on demand, users can select the long-term record mode or a classification record mode in step S2. If selecting the long-term record mode of step S3, the disk drive A of the multi-disc disk drive 5 starts to record video signals immediately in step S4. When the disk drive A finishes recording the disc, the disk drive B follows to automatically start recording video signals. One by one the multi-disc disk drive 5, then, automatically starts next disk drive in proper order. When the last disk drive finishes recording the data or receiving a stop command, the multi-disc disk drive 5 goes to stop step 9. Since the multi-disc disk drive 5 automatically finishes the record of each disk drive in turn, the record time is equal to the continuous record from the first disk drive A to the last disk drive E. Accordingly, the multi-disc disk drive 5 can achieves the purpose of recording video data for a long period of time without manually changing the disc.

When selecting the classification record mode of step S5, users selects one of disk drive 51 in step 6, which is previously predetermined to store one kind of specific data according to the feature of video data shown on the display device 6. In step 7, the multi-disc disk drive 5 starts the appointed disk drive 51, and In step 8, records the specific data in the appointed disk drive 51. So similar kind of data can be recorded on the same disc without frequently changing the disc. When the disk drive finishes recording the disc or receiving a stop command, the multi-disc disk drive 5 goes to stop step 9. Therefore, the multi-disc disk drive 5 is able to record data for a long period of time without discontinuity so as to keep integrality of video data. Meanwhile, it is convenient to share and classify data by means of recording different kinds of data on different discs.

Referring to FIG. 4, the recording method of the present invention according to the second embodiment is shown, wherein a multi-disc disk drive 8 connects with a hard disk 9. A display device 10 connects to the output end of the multi-disc disk drive 8 and the hard disk 9, and a source of A/D digital or analog video signals is connected to the multi-disc disk drive 8 and the hard disk 9. When A/D digital or analog video signals received by the multi-disc disk drive 8 and the hard disk 9, they are transferred to the display device 10 and are firstly recorded by the hard disk 9 as a primary recording unit with bigger storage capacity. Until the hard disk 9 finishes recording completely, the recording is shifted to the multi-disc disk drive 8 for continuously recording so as to increase the recording time without discontinuity. Furthermore, the hard disk 9 with bigger storage capacity is generally able to satisfy most of recording demands. After being recorded by the hard disk 9, those A/D digital or analog video signals can be classified and recorded in the multi-disc disk drive 8 by means of properly selecting the long-term record mode and the classification record mode, mentioned in the first embodiment. Thus, the recording procedure can be simplified without frequently changing the disc, and it is convenience to classify data.

Besides, the multi-disc disk drive 8, although, is explained as the type of disk drives according to the recording method for a disk drive of the present invention, it can also be instead of a disk drive with an exchanger. Meanwhile, the hard disk 9 can be built in the multi-disc disk drive 8, and forms one of storage units of the multi-disc disk drive 8.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A recording method for a disk drive, comprising steps of:
(1) inputting A/D digital or analog video signals;
(2) received A/D digital or analog video signals by a multi-disc disk drive with a plurality of storage areas;
(3) selecting a long-term record mode or a classification record mode of the multi-disc disk drive;
(4) if selecting long-term record mode, the multi-disc disk drive automatically shifts each storage area to continuously record in order; and
(5) if selecting classification record mode, A/D digital or analog video signals are recorded in the predetermined storage area.

2. The recording method for a disk drive of claim 1, wherein the multi-disc disk drive in step (2) connects with a display device to display A/D digital or analog video signals.

3. The recording method for a disk drive of claim 1, wherein said storage areas are different discs.

4. The recording method for a disk drive of claim 1, wherein the multi-disc disk drive is a disk drive with an exchanger.

5. The recording method for a disk drive of claim 1, wherein the multi-disc disk drive includes a plurality of disk drives.

6. The recording method for a disk drive of claim 6, wherein the multi-disc disk drive automatically shifts each disk drive to continuously record in order in step (4).

7. The recording method for a disk drive of claim 1, wherein the multi-disc disk drive includes a hard disk as a primary recording unit to firstly record A/D digital or analog video signals in step (2).

8. The recording method for a disk drive of claim 7, wherein the hard disk externally connects or is built in the multi-disc disk drive.
